(19) United States
(12) Patent Application Publication
(10) Pub. No.: US 2026/0235230 A1
(43) Pub. Date: Aug. 13, 2026

(54) SUPPORT DEVICE

(71) Applicant: Miro Industries, Inc., Heber City, UT (US)

(72) Inventors: Jason Reed Haddock, Heber City, UT (US); Jarrett Welch, Heber City, UT (US); Richard R. Knight, Heber City, UT (US); Samuel Richard Robins, Heber City, UT (US); Chance Spensko, Heber City, UT (US); Kolten Post, Heber City, UT (US); John Post, Heber City, UT (US); Gary JR Kummer, Heber City, UT (US)

(21) Appl. No.: 19/457,125

(22) Filed: Jan. 22, 2026

Related U.S. Application Data
(60) Provisional application No. 63/748,390, filed on Jan. 22, 2025.

(51) Int. Cl. F16L 3/12

(52) U.S. Cl. CPC F16L 3/1226

(57) ABSTRACT

A device includes an elongated base extending along a longitudinal axis between a first end and an opposite second end. The device also includes a first member and a second member each extending from the elongated base and cooperating to define an elongated channel. The elongated base includes a first elongated groove laterally spaced from the first member and a second elongated groove laterally spaced from the second member.

### CROSS-REFERENCE TO RELATED APPLICATIONS

This application claims the benefit of U.S. Patent Application Ser. No. 63/748,390, filed on Jan. 22, 2025; the disclosure of which is incorporated herein by reference in its entirety.

### FIELD

The present disclosure generally relates to a support device. More particularly, but not exclusively, the present disclosure relates to a support device to which a variety of other components may be coupled, and which may be used for the support of objects on a rooftop or other settings.

### BACKGROUND

Unless otherwise indicated herein, the materials described herein are not prior art to the claims in the present application and are not admitted to be prior art by inclusion in this section.

Various objects, including HVAC ductwork, refrigeration lines, electrical/wiring conduit and/or modular walkways, amongst others, may be positioned in a variety of settings, including for example mounted to a wall, hanging from a ceiling, or placed on the rooftop of a building or other structure. Struts or strut channels may be used in these settings for coupling to and/or supporting these items. However, use of current strut channels may suffer from a variety of drawbacks, including for example being difficult to use and for coupling other components, such as support bases, thereto. Existing strut channels may also suffer from reactivity between the material(s) from which they are formed and that of other items coupled thereto. Accordingly, there is a need for further contributions in this area of technology.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, a device includes an elongated base extending along a longitudinal axis between a first end and an opposite second end, and a first member and a second member each extending from the elongated base and cooperating to define an elongated channel. The elongated base includes a first elongated groove laterally spaced from the first member and a second elongated groove laterally spaced from the second member.

In another embodiment, a method includes providing the aforementioned device, positioning a clamp member in the elongated channel, and engaging a fastener member with the clamp member to fix the position of the clamp member in the first elongated channel.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a support device;

FIG. 2 is an alternative, perspective view of the support device of FIG. 1;

FIG. 3 is a top, plan view of the support device of FIG. 1; and

FIG. 4 is an end view of the support device of FIG. 1.

### DETAILED DESCRIPTION

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to a support device. More particularly, but not exclusively, the present disclosure relates to a support device to which a variety of other components may be coupled, and which may be used for the support of objects on a rooftop or other settings. It will be appreciated that embodiments disclosed herein may be employed in a variety of fields and/or operating environments where the functionality disclosed herein may be useful. Accordingly, the scope of the invention should not be construed to be limited to the exemplary implementations and operating environments disclosed herein.

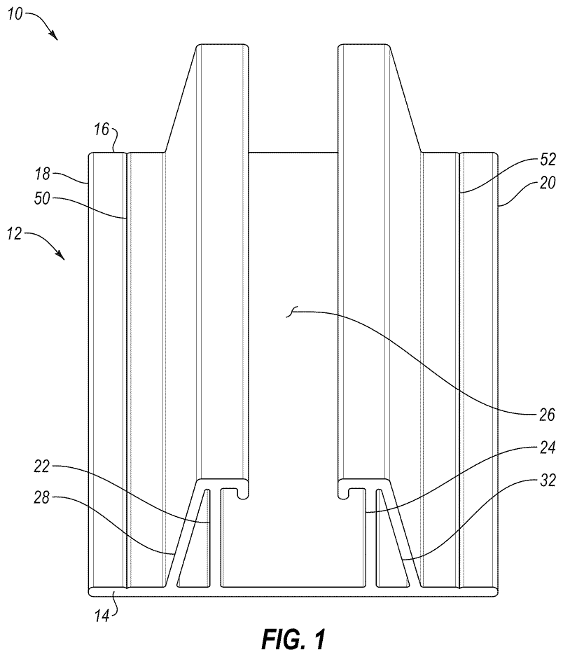

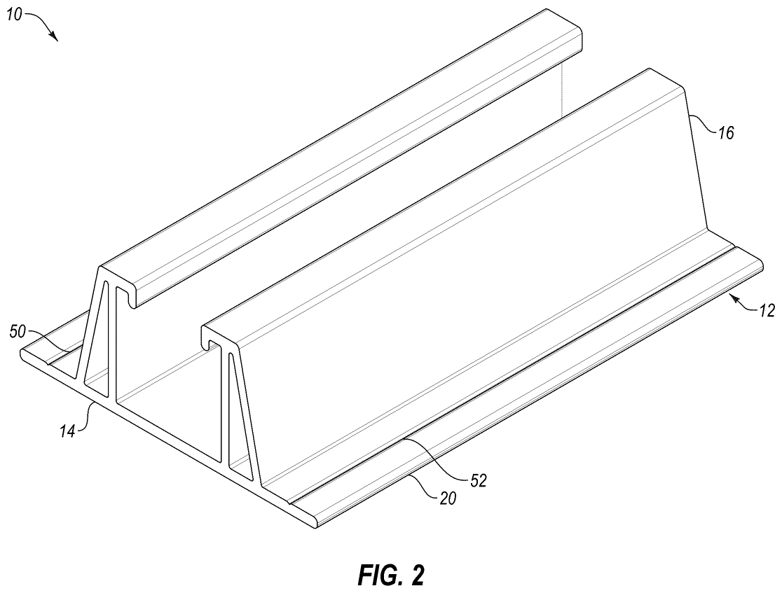

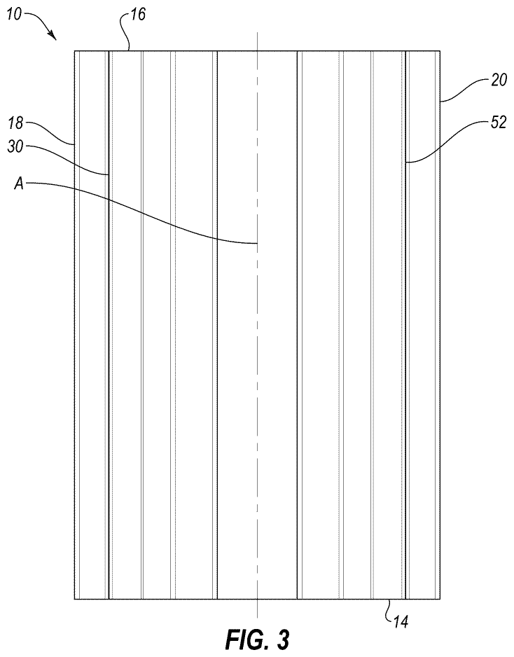

With general reference to FIGS. 1-4 for example, there is illustrated one non-limiting embodiment of a support device 10. The support device 10 includes an elongated base 12 extending along a longitudinal axis A between a first end 14 and an opposite second end 16. The elongated base 12 further includes a first lateral edge 18 extending between the first end 14 and the second end 16, and a second lateral edge 20 positioned opposite of the first lateral edge 18 and also extending between the first end 14 and the second end 16. In the illustrated form, the elongated base 12 generally includes a rectangular configuration, although other shapes and configurations for the elongated base 12 are possible and contemplated. The elongated base 12 may be sized to include a surface area designed or selected to increase the contact area between the support device 10 and a surface on which it may be positioned, such as a rooftop membrane material for example, in order to minimize impact or damage to the surface by the support device 10.

The support device 10 further includes a first member 22 extending from the elongated base 12, and a second member 24 extending from the elongated base 12. In the illustrated form, the first member 22 and the second member 24 each extend orthogonally, or substantially orthogonally, from the elongated base 12. However, variations in the orientation of one or both of the first member 22 and the second member 24 relative to the elongated base 12 are contemplated. The first member 22, the second member 24 and the elongated base 12 cooperate to define an elongated channel 26 which extends between and opens at the first end 14 and the second end 16.

A third member 28 extends obliquely to and between the elongated base 12 and the first member 22, and the third member 28 along with the first member 22 and the elongated base 12 define a first open cavity 30. The first open cavity 30 extends between and opens at the first end 14 and the second end 16 of the elongated base 12. Further, in the illustrated form the first open cavity 30 has a generally triangular configuration, although variations in this configuration may vary depending on the relative orientation between the first member 22, the third member 28 and the elongated base 12. For example, the first open cavity 30 may have a round or rectangular configuration. Further, a fourth member 32 extends obliquely to and between the elongated base 12 and the second member 24, and the fourth member 32 along with the second member 24 and the elongated base 12 define a second open cavity 34. The second open cavity 34 extends between and opens at the first end 14 and the second end 16 of the elongated base 12. Further, in the illustrated form the second open cavity 34 has a generally triangular configuration, although variations in this configuration may vary depending on the relative orientation between the second member 24, the fourth member 32 and the elongated base 12. For example, the second open cavity 34 may have a round or rectangular configuration. Generally speaking, the third member 28 and the fourth member 32 may be positioned relative to the first member 22 and the second member 24, respectively, in a manner which provides support to the first member 22 and the second member 24 to maintain a desired form of the elongated channel 26 even in the presence of external force(s) applied thereto.

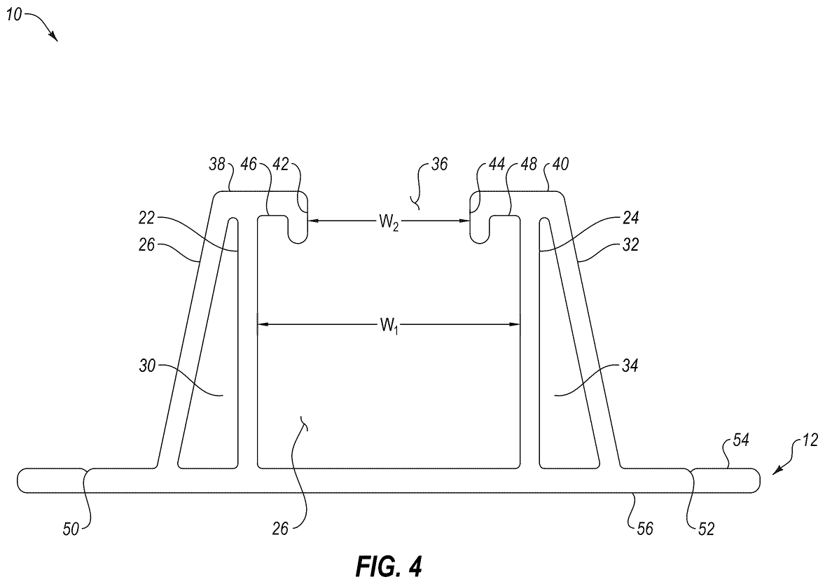

As may be best seen in FIG. 4 for example, the elongated channel 26 generally has a rectangular configuration. However, variations in this configuration are possible. The elongated base 12 defines a portion of the elongated channel 26 and a channel mouth 36 provides access to the elongated channel 26 from a position opposite of the elongated base 12. The channel mouth 36 is partially defined by a first surface 38 which extends from the first member 22 toward the second member 24 and overhangs the elongated channel 26, and a second surface 40 which extends from the second member 24 toward the first member 22 and overhangs the elongated channel 26. The first surface 38 includes a first return 42 which extends toward the elongated base 12, and the second surface 40 includes a second return 44 which extends toward the elongated base 12. In this configuration, the first return 42 and the second return 44 define a pair of slots positioned in the elongated channel 26. More specifically, a first slot 46 is positioned between the first return 42 and the first member 22, and a second slot 48 is positioned between the second return 44 and the second member 24. The elongated channel 26 generally includes a first width w₁ extending between the first member 22 and the second member 24, and the channel mouth 36 includes a second width w₂ extending between the first return 42 and the second return 44. In the illustrated form, the second width w₂ is reduced relative to the first width w₁. In this arrangement, the channel mouth 36 may provide a blocking arrangement which prevents removal of an item from the elongated channel 26 except from the ends thereof or, in some cases, dependent on the orientation of the item relative to the elongated channel 26.

The elongated base 12 also includes a first elongated groove 50 laterally spaced from the first member 22 and a second elongated groove 52 laterally spaced from the second member 24. In this configuration, the elongated channel 26 is positioned between the first elongated groove 50 and the second elongated groove 52. As best shown in FIG. 4 for example, the elongated base 12 includes a first surface 54 (from which each of the first member 22 and the second member 24 extends) positioned opposite of a second surface 56, and each of the first elongated groove 50 and the second elongated groove 52 is formed in the first surface 54 of the elongated base 12 and extends partially into the elongated base 12. Amongst other things, the first elongated groove 50 and the second elongated groove 52 may provide a guide for positioning a fastener (not shown) which may be used to secure positioning of the support device 10 and/or interconnection thereof to one or more other components or devices. For example, in an arrangement where the support device 10 is coupled to a wall or other underlying surface, one or more fasteners may be positioned along one or both of the first elongated groove 50 and the second elongated groove 52 and engaged with the wall or underlying surface through the elongated base 12. In some settings, such as a rooftop where membrane materials which may be damaged by objects positioned on the rooftop have been used, it may be desired to avoid direct positioning or fastening of the support device 10 to the rooftop. In these settings for example, one or more bases or other similar devices may be positioned between the support device 10 and the rooftop, and the support device 10 may be coupled to the one or more bases or other similar devices with one or more fasteners positioned in and extending through one or both of the first elongated groove 50 and the second elongated groove 52.

While not previously discussed, it should be appreciated that the first slot 46 and the second slot 48 may be configured to receive a portion of a coupling member such as a clamp which may be used to couple a component to the support device 10, although forms in which no portion of the coupling member is positioned in the first slot 46 or the second slot 48 are possible and contemplated. By way of non-limiting example, the component may be HVAC ductwork, refrigeration lines, electrical conduit, plumbing lines and/or modular walkways. The coupling member may be slid along the elongated channel 26 until a desired position is achieved, and different portions of the coupling member may be secured with one another by a fastener member to provide an arrangement which clamps a portion of the support device 10 therebetween and fixes the positioning of the coupling member relative to the support device 10.

The support devices described herein may be made from a variety of different materials. In some aspects, the devices may be made from a polymer or plastic material and formed via an extrusion process. However, other variations are possible and contemplated.

In one embodiment, a device includes an elongated base extending along a longitudinal axis between a first end and an opposite second end, and a first member and a second member each extending from the elongated base and cooperating to define an elongated channel. The elongated base further includes a first elongated groove laterally spaced from the first member and a second elongated groove laterally spaced from the second member.

In one form, the device further includes a third member extending between the elongated base and the first member, and a fourth member extending between the elongated base and the second member.

In one aspect, the third member extends obliquely to the first member and the elongated base, and the fourth member extends obliquely to the second member and the elongated base.

In a further aspect, the elongated base, the first member and the third member define a first open cavity and the elongated base, the second member and the fourth member define a second open cavity.

In yet another aspect, the first open cavity and the second open cavity each have a triangular, round, or rectangular configuration.

In still another aspect, the first open cavity and the second open cavity each open at the first end and the second end of the elongated base.

In another form, the elongated base includes a first surface positioned opposite of a second surface, and each of the first member and the second member extends from the first surface.

In one aspect, each of the first elongated groove and the second elongated groove is formed in the first surface of the elongated base.

In another aspect, each of the first elongated grove and the second elongated groove extends partially into the elongated base.

In another form, the elongated channel includes a channel mouth positioned opposite of the elongated base, and the channel mouth includes a reduced width relative to a width extending between the first member and the second member.

In one aspect, the channel mouth is defined by a first surface extending from the first member toward the second member and overhanging the elongated channel, and by a second surface extending from the second member toward the first member and overhanging the elongated channel.

In a further aspect, the first surface includes a first return extending toward the elongated base and the second surface includes a second return extending toward the elongated base.

In yet another aspect, a pair of slots is positioned in the elongated channel, and a first one of the pair of slots is positioned between the first return and the first member and a second one of the pair of slots is positioned between the second return and the second member.

In still another aspect, the first elongated groove is laterally spaced from the first member in a direction which is opposite of the second member and the second elongated groove is laterally spaced from the second member in a direction which is opposite of the first member.

In yet another embodiment, the elongated base further includes a first edge positioned opposite of a second edge, the first elongated groove is positioned between the first member and the first edge of the elongated base, and the second elongated groove is positioned between the second member and the second edge of the elongated base.

In another embodiment, a method includes providing a device as described herein, positioning a clamp member in the elongated channel, and engaging a fastener member with the clamp member to fix the position of the clamp member in the first elongated channel.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device, comprising:
an elongated base extending along a longitudinal axis between a first end and an opposite second end; and
a first member and a second member each extending from the elongated base and cooperating to define an elongated channel;
wherein the elongated base includes a first elongated groove laterally spaced from the first member and a second elongated groove laterally spaced from the second member.

2. The device of claim 1, further comprising a third member extending between the elongated base and the first member, and a fourth member extending between the elongated base and the second member.

3. The device of claim 2, wherein the third member extends obliquely to the first member and the elongated base, and the fourth member extends obliquely to the second member and the elongated base.

4. The device of claim 3, wherein the elongated base, the first member and the third member define a first open cavity and the elongated base, the second member and the fourth member define a second open cavity.

5. The device of claim 4, wherein the first open cavity and the second open cavity each have a triangular, round or rectangular configuration.

6. The device of claim 4, wherein the first open cavity and the second open cavity each open at the first end and the second end of the elongated base.

7. The device of claim 1, wherein the elongated base includes a first surface positioned opposite of a second surface, and each of the first member and the second member extends from the first surface.

8. The device of claim 7, wherein each of the first elongated groove and the second elongated groove is formed in the first surface of the elongated base.

9. The device of claim 7, wherein each of the first elongated grove and the second elongated groove extends partially into the elongated base.

10. The device of claim 1, wherein the elongated channel includes a channel mouth positioned opposite of the elongated base, and the channel mouth includes a reduced width relative to a width extending between the first member and the second member.

11. The device of claim 10, wherein the channel mouth is at least partially defined by a first surface extending from the first member toward the second member and overhanging the elongated channel and by a second surface extending from the second member toward the first member and overhanging the elongated channel.

12. The device of claim 11, wherein the first surface includes a first return extending toward the elongated base and the second surface includes a second return extending toward the elongated base.

13. The device of claim 12, comprising a pair of slots positioned in the elongated channel, wherein a first one of the pair of slots is positioned between the first return and the first member and a second one of the pair of slots is positioned between the second return and the second member.

14. The device of claim 1, wherein the first elongated groove is laterally spaced from the first member in a direction which is opposite of the second member and the second elongated groove is laterally spaced from the second member in a direction which is opposite of the first member.

15. The device of claim 1, wherein the elongated base further includes a first edge positioned opposite of a second edge, the first elongated groove is positioned between the first member and the first edge of the elongated base, and the second elongated groove is positioned between the second member and the second edge of the elongated base.

16. A method, comprising:
providing a device according to claim 1;
positioning a clamp member in the elongated channel of the device; and
engaging a fastener member with the clamp member to fix the position of the clamp member in the first elongated channel.
